(19) United States
(12) Patent Application Publication
(10) Pub. No.: US 2012/0005180 A1
(43) Pub. Date: Jan. 5, 2012

(54) NAVIGATION DEVICE AND METHOD FOR PRESENTING ROAD INFORMATION USING AN ELECTRONIC MAP

(75) Inventor: Shu-Hsi Chen, Taipei City (TW)

(73) Assignee: MITAC INTERNATIONAL CORPORATION, Taoyuan County (TW)

(21) Appl. No.: 13/164,300

(22) Filed: Jun. 20, 2011

(30) Foreign Application Priority Data
Jun. 30, 2010 (TW) 099121440

(51) Int. Cl. G06F 17/30

(52) U.S. Cl. 707/705; 707/E17.005

(57) ABSTRACT

A navigation device includes a display screen, a storage unit and a processing unit. The storage unit stores a map database. The map database includes electronic map data, and a plurality of road information each including a road name and a corresponding road speed-limit. The processing unit is operable to access a portion of the electronic map data in the map database, to access the road information corresponding to at least one road of the electronic map data accessed by the processing unit, to render the electronic map data accessed thereby so as to generate an electronic map image in which the at least one road of the electronic map data accessed by the processing unit has a visible indication that corresponds to the road speed-limit of the road information accessed by the processing unit, and to provide the electronic map image to the display screen for display.

### CROSS-REFERENCE TO RELATED APPLICATION

This application claims priority of Taiwanese Application No. 099121440, filed on Jun. 30, 2010.

### BACKGROUND OF THE INVENTION

1. Field of the Invention

The present invention relates to a navigation device, more particularly to a navigation device using a visible indication to represent a road speed-limit.

2. Description of the Related Art

A vehicle navigation device stores road information including road names, road speed-limits and so on. For the purpose of reminding drivers not to exceed a road speed-limit, a conventional vehicle navigation device may present the road speed-limit of a road where the drivers are currently at.

However, when a driver is on one road and wish to know if there is any other road with a higher speed-limit nearby for the purpose of changing routes, the conventional vehicle navigation device may not provide such a function. Moreover, when a satellite navigation signal is weak or not received, the conventional navigation device is operated in an off-line mode. Since the conventional navigation device is incapable of showing which road the driver is currently at in the off-line mode, the road speed-limit of the road may not be presented. The driver may then only acquire information about the road speed-limit by watching for roadside physical speed-limit signs.

Furthermore, when there is ongoing construction, an event, or an accident, road speed-limits of nearby roads may be temporarily changed. Moreover, some roads have specific regulations for road speed-limit in different time periods, such as roads around schools have lower road speed-limits during time periods before classes begin and after classes end. Currently, such road information about road speed-limit may not be properly presented using the conventional vehicle navigation device.

### SUMMARY OF THE INVENTION

Therefore, an object of the present invention is to provide a navigation device using a visible indication to represent a road speed-limit.

Accordingly, the navigation device of the present invention includes a display screen, a storage unit and a processing unit. The storage unit stores a map database.

The map database includes electronic map data, and a plurality of road information each including a road name and a corresponding road speed-limit.

The processing unit is coupled to the display screen and the storage unit. The processing unit is operable to access a portion of the electronic map data in the map database, to access the road information corresponding to at least one road of the electronic map data accessed by the processing unit, to render the electronic map data accessed thereby so as to generate an electronic map image in which the at least one road of the electronic map data accessed by the processing unit has a visible indication that corresponds to the road speed-limit of the road information accessed by the processing unit, and to provide the electronic map image to the display screen for display.

Another object of the present invention is to provide a method for presenting road information using an electronic map.

Accordingly, the method of the present invention is to be performed by a navigation device that includes a display screen, a storage unit and a processing unit. The storage unit stores a map database. The map database includes electronic map data, and a plurality of road information each including a road name and a corresponding road speed-limit. The method comprises:

a) configuring the processing unit to access a portion of the electronic map data stored in the map database;

b) configuring the processing unit to access the road information corresponding to at least one road of the electronic map data accessed in step a); and

c) configuring the processing unit to render the electronic map data accessed in step a) so as to generate an electronic map image in which said at least one road of the electronic map data accessed in step a) has a color that corresponds to the road speed-limit of the road information accessed by the processing unit in step b), and to provide the electronic map image to the display screen for display.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram illustrating a preferred embodiment of the navigation device of the present invention;

FIG. 2 is a flowchart illustrating a method performed by the preferred embodiment of the navigation device of the present invention for presenting road information;

FIG. 3 is a schematic diagram illustrating a map image, in which roads in the map image have no visible indication for representing road speed-limit;

FIG. 4 is a schematic diagram illustrating a map image, in which roads in the map image have colors for representing road speed-limits; and

FIG. 5 is a schematic diagram illustrating a map image, in which roads in the map image have numerical indications for showing road speed-limits.

### DETAILED DESCRIPTION OF THE PREFERRED EMBODIMENT

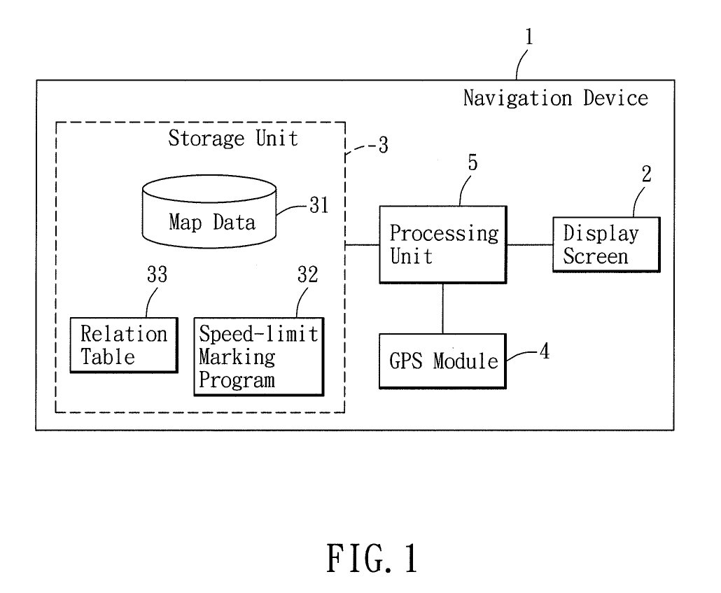

Referring to FIG. 1, a preferred embodiment of a navigation device 1 of the present invention is to be disposed in a vehicle, and includes a casing (not shown), a display screen 2 disposed on a surface of the casing, a storage unit 3 disposed in the casing, a global positioning system (GPS) module 4, and a processing unit 5.

The storage unit 3 stores a map database 31, a speed-limit marking program 32, and a relation table 33. The map database 31 includes electronic map data, and a plurality of road information, each including a road name, a corresponding road category and a corresponding road speed-limit. Preferably, the road information corresponding to a part of roads of the electronic map data in the map database 31 includes different road speed-limits for different time periods. For example, roads around school may have road speed-limits reduced from 80 km/hr to 40 km/hr during time periods before classes begin and after classes end.

The processing unit 5 is coupled to the display screen 2, the storage unit 3 and the GPS module 4. The GPS module receives GPS information, and transmits the GPS information to the processing unit 5. The processing unit 5 acquires a current position with reference to the GPS information.

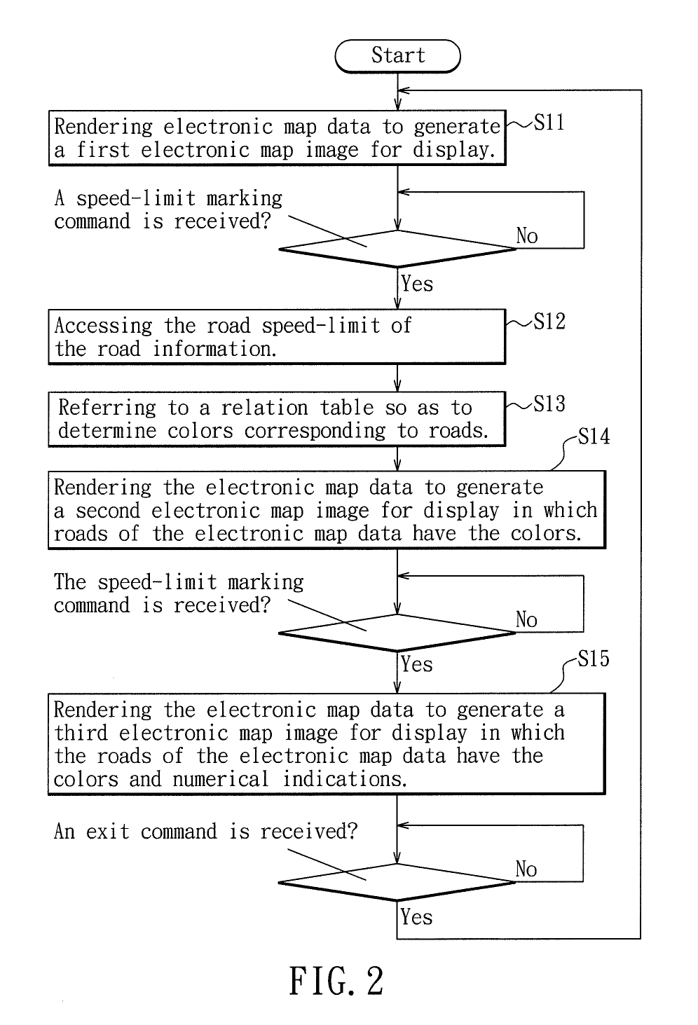

Referring to FIG. 2, a method performed by the preferred embodiment of the navigation device of the present invention for presenting road information is illustrated. The navigation device is operable in a navigation mode, i.e., a planned path being presented in a map image. The navigation device is further operable in a free steering mode, i.e., merely the current position of the vehicle being presented in the map image. The navigation device is still further operable in an off-line mode, i.e., users may choose any map image for display. The method includes:

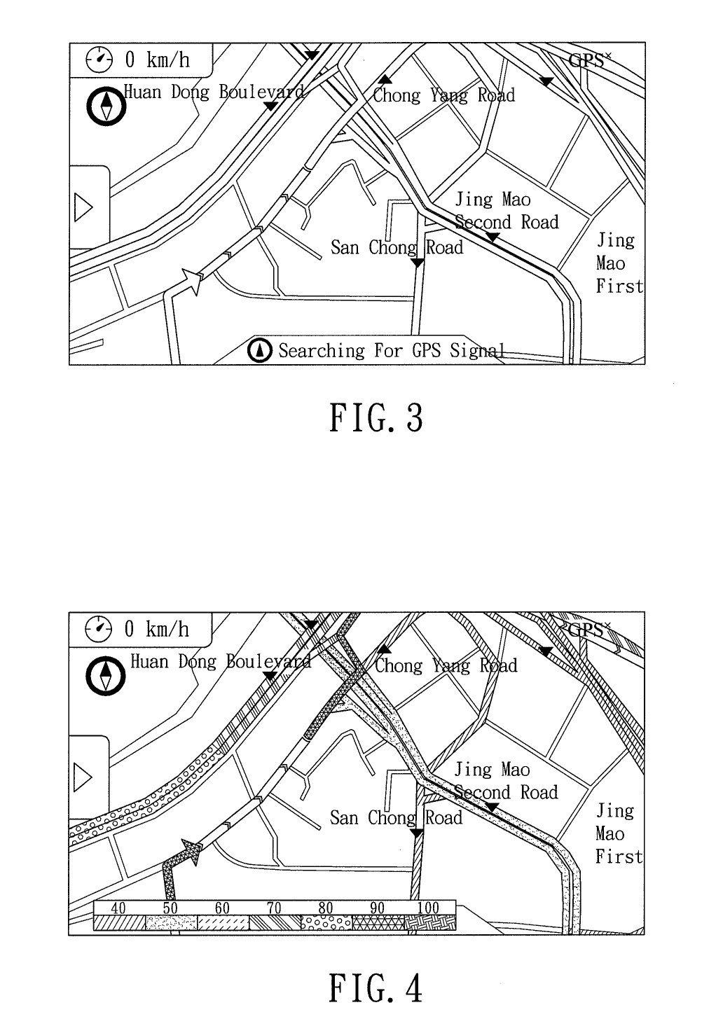

step 11, configuring the processing unit 5 to access a portion of the electronic map data stored in the map database 31 according to the current position; configuring the processing unit 5 to access the road information corresponding to at least one road of the electronic map data; and configuring the processing unit 5 to render the electronic map data so as to generate a first electronic map image, and to provide the first electronic map image to the display screen 2 for display as illustrated in FIG. 3. In the map image illustrated in FIG. 3, roads of the map image are not colored according to road speed-limits thereof, but should not be limited to the disclosure of this embodiment. For example, a national highway may have a color of blue, a prefectural road may have a color of yellow, and others may have a color of gray in other embodiments of the invention.

When a user operates the navigation device 1, such as operating a specific button or selecting a speed-limit color marking option in a function menu, the processing unit 5 receives a speed-limit marking command generated according to the aforesaid operation, such that the speed-limit marking program 32 is executed by the processing unit 5. The speed-limit marking program 32 configures the processing unit 5 to perform the following steps:

step 12, configuring the processing unit 5 to access the road speed-limit of the road information corresponding to roads of the electronic map data accessed in step 11, for example, Huan Dong Boulevard has a speed-limit of 70 km/hr, Jing Mao Second Road has a speed-limit of 50 km/hr, and San Chong Road has a speed-limit of 40 km/hr. If the road information corresponding to a part of the roads of the electronic map data in the map database 31 includes different road speed-limits for different time periods, the processing unit 5 refers to a clock signal generated from a clock (not shown) of the navigation device 1 when accessing the road speed-limit of the road information;

step 13, configuring the processing unit 5, in response to receipt of the speed-limit marking command, to refer to the relation table 33, that is stored in the storage unit 3 and that defines relationships between possible values of the road speed-limit and corresponding colors to be used for marking, so as to determine colors corresponding to the roads in the first electronic map image displayed on the display screen 2. In this embodiment, roads with a speed-limit of 70 km/hr have a color of yellow, roads with a speed-limit of 50 km/hr have a color of orange, and roads with a speed-limit of 40 km/hr have a color of red; and

step 14, configuring the processing unit 5 to render the electronic map data accessed in step 11 so as to generate a second electronic map image in which the roads of the electronic map data have the colors determined in step 13, and to provide the second electronic map image to the display screen 2 for display as illustrated in FIG. 4. Preferably, the second electronic map image generated by the processing unit 5 further includes a graphic indication of the relation table 33. It should be noted that, different shadings are adopted for different colors in FIG. 4. However, in practice, the roads of the electronic map data have the colors but not the shadings for representation of the corresponding road speed-limits.

Specifically, processing order of the aforesaid steps 11 to 14 is not limited to the disclosure herein. For example, before the processing unit 5 is configured to provide the first electronic map image to the display screen 2 for display in step 11, the processing unit 5 may execute the speed-limit marking program 32, i.e., steps 12 to 14 being performed without receiving the speed-limit marking command. A part of step 11 (i.e., configuring the processing unit 5 to access the portion of the electronic map data stored in the map database 31 according to the current position) and steps 12 to 14 may be performed without the user being aware of the same. In other words, the display screen 2 directly displays the second electronic map image, in which the roads of the electronic map data have the colors that determined in step 13 as shown in FIG. 4, without displaying the first electronic map image shown in FIG. 3.

In this way, the user may clearly recognize, from the second electronic map image displayed on the display screen 2, whether a road where the user is currently at has the same color as those of nearby roads so as to know changes in the road speed-limits. The user may see directly if there is any road with a higher road speed-limit nearby, and may view the graphic indication of the relation table 33 displayed by the display screen 2 for a value of the road speed-limit. Moreover, when the user drives on roads around school during time periods before classes begin and after classes end, the user may clearly receive information from the second electronic map image that vehicle speed should be reduced so as to ensure pedestrian safety.

In this embodiment, the user may further operate the navigation device 1, such as operating the specific button or selecting a speed-limit numerical indication marking option in the function menu. The processing unit 5 receives the speed-limit marking command generated according to the aforesaid operation such that step 15 is performed.

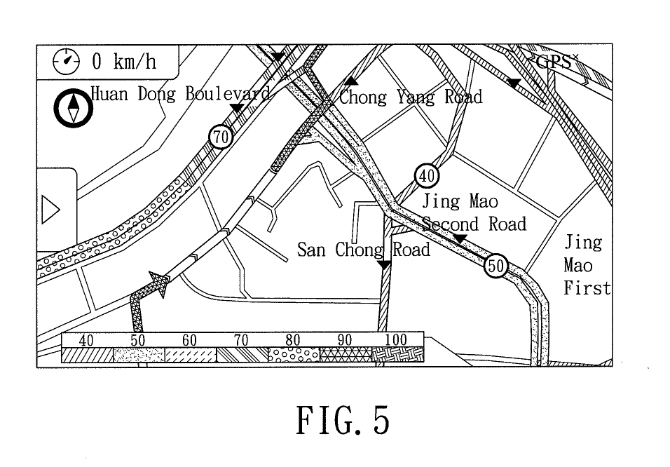

In step 15, the processing unit 5 is configured, in response to receipt of the speed-limit marking command, to render the electronic map data accessed in step 11 so as to generate a third electronic map image. In the third electronic map image, the roads of the electronic map data have the colors determined in step 13, and numerical indications corresponding to the roads in the third electronic map image and corresponding to the road speed-limits of the road information accessed by the processing unit in step 12. Moreover, the processing unit 5 is configured to provide the third electronic map image to the display screen 2 for display as illustrated in FIG. 5. At this time, the graphic indication of the relation table may be omitted from the third electronic map image.

In the preferred embodiment, when the user operates the navigation device 1 once again, such as operating the specific button or selecting a cancelling speed-limit marking option in the function menu, the processing unit 5 receives an exit command generated according to the aforesaid operation such that the first electronic map image generated in step 11 is provided once again to the display screen 2 for display as illustrated in FIG. 3.

Furthermore, the navigation device 1 is configured to receive traffic information from the Traffic Message Channel (TMC). When the speed-limit color marking option in the function menu of the navigation device 1 is selected, the processing unit 5 is configured to temporarily store the traffic information, to retrieve information about road speed-limits with reference to event codes of the traffic information, and to perform steps 13 and 14 according to the retrieved information about road speed-limits. Alternatively, the user may customize retrieval rules for retrieving road speed-limits with reference to the traffic information.

In this way, if a road ahead is under traffic control resulting from construction, and a road speed-limit thereof is reduced from 60 km/hr to 20 km/hr, the user may receive information about the road speed-limit ahead instantly from the second or third electronic map image so as to be able to reduce vehicle speed or to change route.

When an event corresponding to the event code is over, for example, the construction is finished and the road ahead is no longer under traffic control, traffic information is updated from the TMC. Therefore, the processing unit 5 is configured to resume presentation of the road speed-limit of the road information of the electronic map data stored in the storage unit 3. If the processing unit 5 does not receive the updated traffic information, the processing unit 5 may be configured to delete the temporarily stored traffic information after a predetermined time interval (such as two hours) from receipt of the temporarily stored traffic information.

Specifically, the method for presentation of traffic information using an electronic map of the present invention provides users with options including the speed-limit color marking option and the speed-limit numerical indication marking option. However, the method should not be limited to the disclosure as illustrated in FIG. 2. For example, virtual keys may be provided for determining which way the road speed-limit is to be presented.

In summary, road speed-limits of roads are presented clearly in the second electronic map image and the third electronic map image displayed on the display screen 2 of the navigation device 1. The user may know road speed-limits of the road where the user is currently at and of the roads nearby so as to determine which route to travel. Furthermore, even if the satellite navigation signal is weak or not received, the user may still select a portion of the electronic map data for display, and may operate the specific button or the function menu so as to acquire information about road speed-limits with relative ease.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A navigation device comprising:
a display screen;
a storage unit storing a map database, said map database including electronic map data, and a plurality of road information, each including a road name and a corresponding road speed-limit; and
a processing unit coupled to said display screen and said storage unit, said processing unit being operable to access a portion of the electronic map data in said map database, to access said road information corresponding to at least one road of the electronic map data accessed by said processing unit, to render the electronic map data accessed thereby so as to generate an electronic map image in which said at least one road of the electronic map data accessed by said processing unit has a visible indication that corresponds to said road speed-limit of said road information accessed by said processing unit, and to provide the electronic map image to said display screen for display.

2. The navigation device as claimed in claim 1, wherein, in the electronic map image generated by said processing unit, said at least one road of the electronic map data accessed by said processing unit has a color that corresponds to said road speed-limit of said road information accessed by said processing unit.

3. The navigation device as claimed in claim 2, wherein said storage unit further stores a relation table that defines relationships between possible values of said road speed-limit and corresponding colors to be used for marking, said processing unit referring to said relation table so as to determine the color for said at least one road in the electronic map image to be displayed on said display screen.

4. The navigation device as claimed in claim 3, wherein the electronic map image generated by said processing unit further includes a graphic indication of said relation table.

5. The navigation device as claimed in claim 2, wherein said processing unit is responsive to receipt of a speed-limit marking command such that the color of said at least one road in the electronic map image corresponds to said road speed-limit of said road information accessed by said processing unit, and is further responsive to receipt of a subsequent speed-limit marking command such that said at least one road in the electronic map image has a numerical indication that corresponds to said road speed-limit of said road information accessed by said processing unit.

6. The navigation device as claimed in claim 1, wherein, in the electronic map image generated by said processing unit, said at least one road of the electronic map data accessed by said processing unit has a numerical indication that corresponds to said road speed-limit of said road information accessed by said processing unit.

7. The navigation device as claimed in claim 1, wherein:
said road information corresponding to a part of the roads of the electronic map data in said map database includes different road speed-limits for different time periods; and
said processing unit refers to a clock signal when accessing said road speed-limit of said road information corresponding to said at least one road of the electronic map data accessed by said processing unit.

8. A method for presenting road information using an electronic map, the method to be performed by a navigation device that includes a display screen, and a storage unit, the storage unit storing a map database, the map database including electronic map data, and a plurality of road information, each including a road name and a corresponding road speed-limit, the method comprising:
a) accessing a portion of the electronic map data stored in the map database;
b) accessing the road information corresponding to at least one road of the electronic map data accessed in step a); and
c) rendering the electronic map data accessed in step a) so as to generate an electronic map image in which said at least one road of the electronic map data accessed in step a) has a color that corresponds to the road speed-limit of the road information accessed by the processing unit in step b), and providing the electronic map image to the display screen for display.

9. The method as claimed in claim 8, wherein, in step c), the color for said at least one road in the electronic map image to be displayed on the display screen is determined with reference to a relation table, that defines relationships between possible values of the road speed-limit and corresponding colors to be used for marking.

10. The method as claimed in claim 9, wherein, in step c), the electronic map image further includes a graphic indication of the relation table.

11. The method as claimed in claim 8, wherein, in step c), the electronic map image further includes a numerical indication corresponding to said at least one road in the electronic map image and corresponding to the road speed-limit of the road information accessed in step b).

12. The method as claimed in claim 11, wherein, in step c), in response to receipt of a speed-limit marking command, the color of the at least one road in the electronic map image corresponds to the road speed-limit of the road information accessed by the processing unit in step b), and in response to receipt of a subsequent speed-limit marking command, said at least one road in the electronic map image has the numerical indication.

13. The method as claimed in claim 8, the road information corresponding to a part of the roads of the electronic map data in the map database including different road speed-limits for different time periods, wherein, in step b), the road speed-limit of the road information is accessed with reference to a clock signal.
